(19) United States
(12) Patent Application Publication
(10) Pub. No.: US 2026/0335897 A1
(43) Pub. Date: Oct. 29, 2026

(54) MULTI-WELL POTENTIOSTAT

(71) Applicant: THE TRUSTEES OF INDIANA UNIVERSITY, BLOOMINGTON, IN (US)

(72) Inventors: LANE ALLEN BAKER, BLOOMINGTON, IN (US); ANDREW W. ALEXANDER, BLOOMINGTON, IN (US); BENJAMIN GERROLL, BLOOMINGTON, IN (US)

(73) Assignee: THE TRUSTEES OF INDIANA UNIVERSITY, BLOOMINGTON, IN (US)

(21) Appl. No.: 18/881,013

(22) PCT Filed: Jun. 28, 2023
(86) PCT No.: PCT/US2023/026445

§ 371 Date: Jan. 3, 2025

Related U.S. Application Data
(60) Provisional application No. 63/358,553, filed on Jul. 6, 2022.

(51) Int. Cl. B01L 3/00

(52) U.S. Cl. CPC B01L 3/5085; B01L 2300/0645

(57) ABSTRACT

A multi-well potentiostat for rapidly performing chemical analysis on multiple different fluid solutions. Each separate well of the microplate may be configured with individual separately addressable electrodes which may be activated individually, in groups, or simultaneously at the same time.

### BACKGROUND

Rapid screening of chemical libraries has been important for the development of novel instruments and methods. However, instruments capable of rapid screening using electrochemical methods have consistently lagged behind other devices that use spectroscopic or mass spectrometric approaches. Screening more samples at the same time using the electrochemical approach is of significant interest, especially given the recent renaissance in electro-organic synthesis. Systematically testing different substrates, electrodes, cell geometries, electrochemical methods (i.e. constant potential vs. constant current vs. alternating current) and conditions one at a time increases the length of time required to sufficiently characterize a chemical reaction in a sample. Thus it has become more and more important to develop high-throughput electrochemical devices and methods to enable screening large numbers of samples and conditions.

High-throughput electrochemical assessment can be performed serially or simultaneously. In one example of a serial process, a microplate set on a mobile stage may be arranged to move in x-y directions. Individual wells of the microplate are moved into position one after the other and a three-electrode bundle is lowered into the solution to conduct an electrochemical experiment, repeating this process for each separate well on the plate. This approach facilitates evaluation of different solution conditions and electrochemical settings in a single experimental setup. It also means that only one potentiostat is required, rendering this approach cost effective. In some cases, however, a microplate may include dozens, or possibly hundreds of individual wells making it very time intensive to test the solution in each well separately. Furthermore, to avoid cross contamination, at least every other well must be a “wash” well, limiting the number of conditions that can be tested. Testing each condition one at a time means significantly more time to complete all the tests.

Parallel investigation generally involves running electrochemical experiments in each condition simultaneously. For example, a single potentiostat may be connected to a 64-channel current follower to allow all working electrodes in each well of the microplate to function at the same time. This allows the electrocatalytic activity to be tested simultaneously on multiple individual working electrodes. However, the working electrodes in this configuration are not isolated into individual solution wells and thus are subjected to the same potential waveform. While this enables screening of a large number of working electrodes, only a single substrate and solution can be explored at a time. Further, the potentials that can be screened in an experiment are limited without individual control over each electrode. Achieving control over the potential or current applied to multiple working electrodes requires multiple individual dedicated potentiostats. This quickly becomes prohibitively expensive as an individual potentiostat may cost in excess of $20,000.

### SUMMARY

Disclosed is a multi-well potentiostat for rapidly performing chemical analysis on multiple different solutions. The disclosed potentiostat incorporates individually addressable working electrodes operating in isolated solution environments simultaneously. For example, each separate fluid well of a microplate may be configured with individual electrodes which may be activated individually, in groups, altogether at about the same time, or any combination thereof.

In another aspect, a potentiostat of the present invention may be configured to integrate with an existing microplate to reduce or eliminate downtime for integration into existing equipment. The disclosed potentiostat may be operable to perform electrochemical screening by conducting multiple individual experiments effectively and simultaneously in a footprint that matches standard size microplates having 12, 48, 96, 384, 1536, or more individual wells. Any suitable number of wells may be included in the microplate, and the disclosed potentiostat may be configured accordingly. Also, any suitable redox mediator may be used in the procedure, such as potassium ferricyanide, ruthenium hexamine, and ferrocene methanol to name a few non-limiting examples.

Further forms, objects, features, aspects, benefits, advantages, and examples will become apparent from the detailed description and drawings provided herewith.

### BRIEF DESCRIPTION OF THE DRAWINGS

FIG. 1 is a component diagram illustrating one example of components that may be included in a multi-well potentiostat of the present disclosure.

FIG. 2 is a component diagram illustrating another example of components that may be included in a multi-well potentiostat of the present disclosure.

FIG. 3 is a cutaway view of a single fluid well that may be included in a multi-well potentiostat of the present disclosure.

FIG. 4 is an exploded view of a microplate incorporating the fluid wells illustrated in FIG. 3.

FIGS. 5-8 are signal diagrams illustrating examples of time varying signals that may be applied to samples using the potentiostat of the present disclosure.

### DETAILED DESCRIPTION

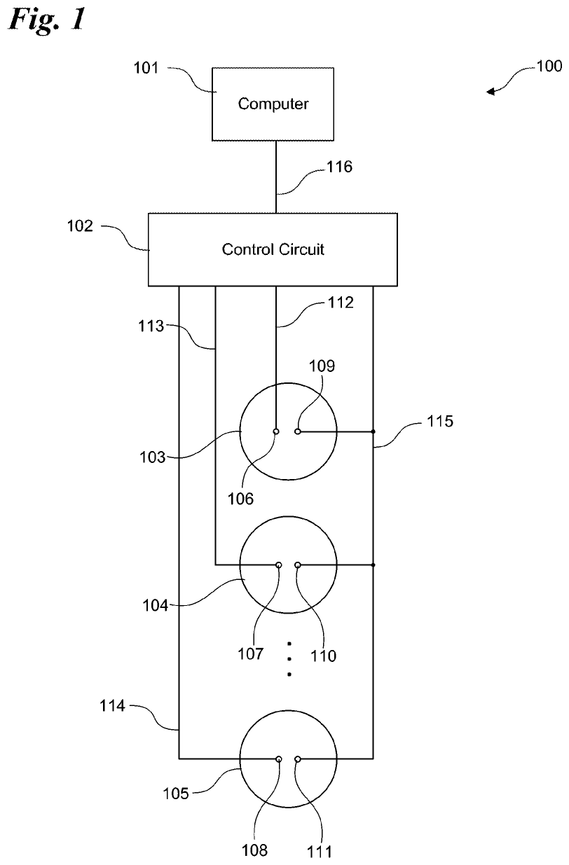

Illustrated at 100 and FIG. 1 are components that may be included in a multi-well potentiostat of the present disclosure. Individual fluid wells 103-105 are isolated and separate from one another so that the contents of each well cannot intermingle. Separate Quasi-Reference Counter (QRC) electrodes 106-108 are positioned to extend into the fluid wells 103-105 and are electrically connected to a control circuit 102 via corresponding individual test leads 112-114. Each electrode 106-108 is thus independently addressable by control circuit 102.

The electrodes 106-108 may be arranged and configured to extend vertically into the corresponding fluid wells 103-105 thus electrically providing for contact between the electrodes and the fluid in each well. Each fluid well 103-105 also includes a working electrode 109-111 which is also positioned in the fluid well. The working electrodes are then electrically connected to the control circuit 102 via a single lead 115. In this configuration, an electric signal may be passed between the QRC electrodes 106-108 and the corresponding working electrodes 109-111. The control circuit 102 is configured to generate this electric signal, analyze the results for each specimen in each fluid well, and send the resulting data to a computer 101 via the communication link 116.

In this configuration, independent chemical analysis may be performed on a specimen in each fluid well separately from the others. For example, multiple individual tests may be performed by using the control circuit 102 to generate multiple different time varying signals for each of the individual QRC electrodes thus allowing different types of analysis to be performed simultaneously on multiple specimens, and also allowing differing results to be obtained for each specimen. In another example, control circuit 102 may generate the same time varying signal for all electrodes 106-108 thus allowing multiple specimens be tested in a similar way at the same time to yield separate individual results for each specimen.

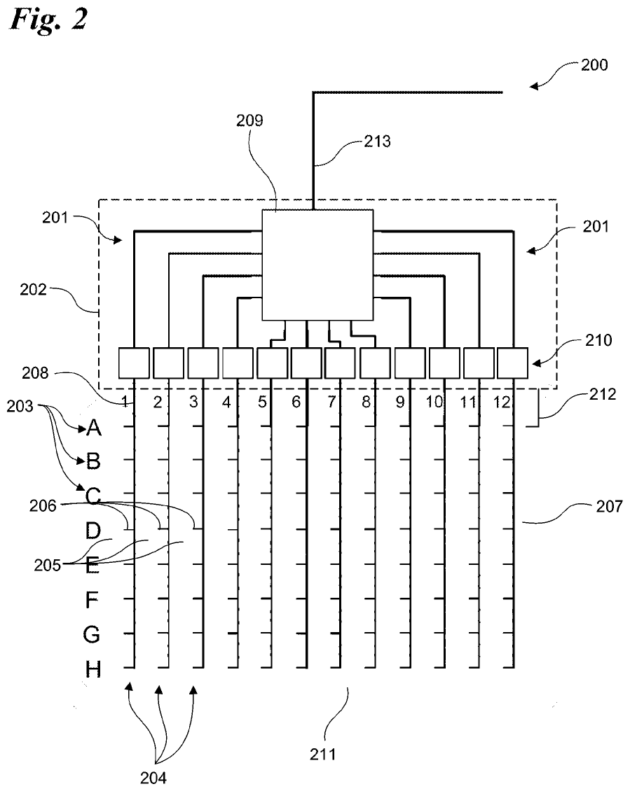

Illustrated at 200 in FIG. 2 are components similar to those shown in FIG. 1 that may be included in another example of a multi-well potentiostat of the present disclosure. A microplate 211 includes multiple fluid wells 205 of which there may be dozens or hundreds depending on the size of the microplate. In this example, the microplate 211 defines 96 individual separate fluid wells 205, but any suitable number may be included in a microplate like the one shown at 200.

A control circuit 202 optionally includes a master controller 209 that is electrically connected to multiple separate slave controllers 210 by multiple individual communication links 201. The master controller 209 or the slave controllers 210 may include a processor, Field Programmable Gate Array (FPGA), memory, operational amplifiers, switching devices (solid state or mechanical), or other circuits programmed to interact with each other logically and/or electrically to provide the disclosed testing functionality. In one example, the slave controllers may include an FPGA electrically connected to one or more electrodes 206 arranged and configured to analyze fluid specimens in corresponding fluid wells 205. Depending on the size and preferred arrangement of the microplate, multiple fluid wells 205 may be arranged in a grid as shown organized in rows 203 marked A-H and columns 204 marked 1-12. Although 96 fluid wells are illustrated at 200, any suitable number of fluid wells may be included in a microplate like this one. An electrode 206 is positioned in each well, preferably extending downward into the fluid well from above.

A common working electrode 207 is also electrically connected to the control circuit at 212. In this example, the working electrode is common to all of the fluid wells 205 in the microplate 211. In another example, the control circuit 202 may be electrically connected to multiple individual working electrodes 207. The individual working electrodes may electrically interact with one or more individual fluid wells, either separately, or in groups. The separate electrodes may then be electrically connected to a common working electrode input of control circuit 202. Thus a multi-well potentiostat of the present disclosure may be configured to use a single working electrode, or multiple separate working electrodes electrically connected to the control circuitry.

In the example shown at 200, the electrodes 206 in one column 204 are electrically connected to the master controller 209 via an eight channel potentiostat slave controller. The slave controller in this example has eight separate channels so that the QRC electrode 206 inserted into each fluid well for a given column 204 can be independently controlled with different signals. The master and slave controllers thus may cooperate to separately control the electric potential of a specific QRC electrode, all QRC electrodes together, separate groups of QRC electrodes, or any combination thereof.

In another aspect, the control circuit 202 is operable to measure the current flowing through each individual electrode 206. In one example, a control potential (voltage) is sent to an operational amplifier (“op-amp”) in the master or the slave controllers. The op-amp is configured to convert the signal to an output voltage applied through the electrodes 206 of each of the fluid wells. The resulting current through the individual electrodes is measured across a sense resistor in the control circuit 202. The slave controller optionally includes this sense resistor, and thus there may be one resistor per channel (i.e. per column 204). The measured current may be converted to a digital signal by a conversion circuit which may include any suitable circuitry such as a Digital to Analog Converter (DAC).

With the potentiostat of the present disclosure, all 96 of the fluid wells shown at 200 may be individually tested by activating the slave controllers according to predefined test parameters specifying the signal to apply, and the sequence of which electrodes to apply the signal to and when. The resulting data is made available to a computer or other electronic device by the control circuit 209 via a communication link 213. This link may be maintained as a wireless network connection implemented using Bluetooth, Wifi, or other suitable wireless protocol, or via a wired connection using any suitable network protocol suitable for such a connection.

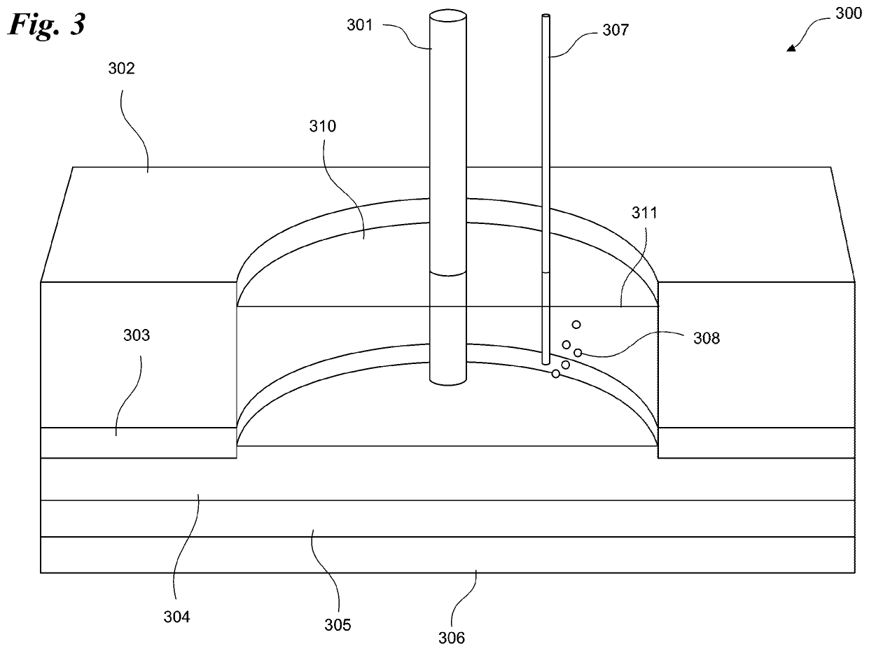

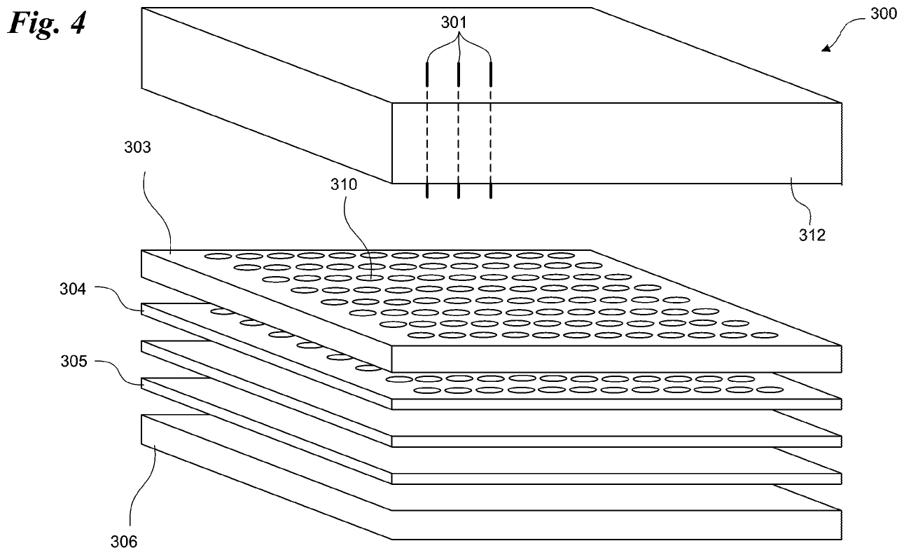

FIGS. 3 and 4 illustrate at 300 another example of a potentiostat according to the current disclosure. FIG. 3 illustrates a close-up cutaway view of a single fluid well while FIG. 4 shows an exploded view of the overall arrangement of a microplate having 96 such fluid wells. As noted earlier, the multi-well potentiostat discussed here may have as few as one or two cells, or as many as a thousand or more. No particular limitation on the number of fluid wells is inherent in the disclosed potentiostat. FIGS. 2, 3, and 4 show a design that matches a commercially available 96 well microplate, and this may be preferable because it allows for the disclosed potentiostat to be easily retrofitted to existing equipment configured to use microplates with 96 fluid wells. However, other sizes of microplates are in use, or may be put into use in the future, and the disclosed concepts are easily adaptable to almost any microplate configuration.

The well plate assembly shown in FIGS. 3 and 4 includes a top plate 302 which in this example may be made from a nonconductive material such as glass, or a nonconductive polymeric material such as polyetheretherketone (PEEK). The disclosed QRC electrodes 301 may be held in place over the fluid well 310 by a cover 312 shown in FIG. 4. A separate tube 307, such as a gas sparging needle, is optionally included to allow the disclosed potentiostat to control a gas flow 308 into the fluid well before, during, and/or after the analysis is complete. The electrodes 301 and the tubes 307 for each fluid well may be mounted to the cover 312. The cover 312 may be positioned above the top plate 302 to hold the electrodes 301 in place and optionally to reduce or eliminate contamination of the fluid specimens in each fluid well 310. For example, cover 312 may be configured to hermetically seal the fluid wells to allow for individual conditions to be imposed on individual fluid wells. A sealed cover optionally provides for the introduction of different gases to different fluid wells via tube 307 prior to, during, or after the testing procedure takes place.

A gasket 303 may be included that is optionally made of any suitable gasket material such as polydimethylsiloxane (PDMS) and may be positioned between the top plate 302 and a working electrode plate 304. The top plate 302 and the gasket 303 may be positioned adjacent one another as shown and may together define the sides of fluid well 310. In one specific example, each well may be 7 mm in diameter and, when assembled as shown, may thus be configured to retain up to 500 μL of fluid 311 for analysis.

The working electrode plate 304 may include a raised portion that extends up into the fluid well 310 thus allowing gasket 303 to hermetically seal the inside walls of the fluid well 310 to the working electrode plate 304. In this example, the working electrode plate 304 defines the bottom of the fluid well 304 while the gasket 303 and the top plate 302 define the walls of the fluid well. A conductive plate 305 is optionally included to electrically connect the working electrode plate 304 with one or more wire leads (like lead 115 in FIG. 1) that are configured to electrically connect the working electrode plate 304 with the disclosed control circuits. A bottom plate 306 may be included and may be made of an electrically insulative material like PEEK or any other suitable alternative.

In one example, the working electrode 304 is made using a glassy carbon plate (e.g. 110 mm×73 mm×3 mm). Before assembling the bottom well plate, the glassy carbon is optionally sequentially polished on a Buehler polishing pad with alumina slurries decreasing in size from 0.3 μm to 0.05 μm. In between each polishing step, the glassy carbon may be sonicated in isopropyl alcohol with activated carbon. After the final polishing step, the working electrode may be again sonicated in isopropyl alcohol containing activated carbon, optionally followed by a brief sonication in water.

In another aspect, the QRC electrodes of the present disclosure may include silver wire (e.g. Millipore Sigma, 1 mm diameter, 99.9%) which may be cut into 25 mm long pieces. The wires may be briefly sanded to remove the top layer of oxides, then immersed in solution containing 1 M FeCl₃ and 1 M HCl for 5 seconds each to provide a layer of AgCl on the surface.

In one example of the disclosed potentiostat in operation, the cover 312, with the electrodes 301 and tubes 307 in place, is placed on top of the well plate assembly (the combination of 302-306). Prior to application of an electrical potential via the electrode 301, oxygen is optionally removed from each fluid well 310 by sparging each well with an inert gas such as argon via the tube 307. The control circuits of the present disclosure may then be activated to apply a continuous or time varying signal to the QRC electrodes 301 of each fluid well 310.

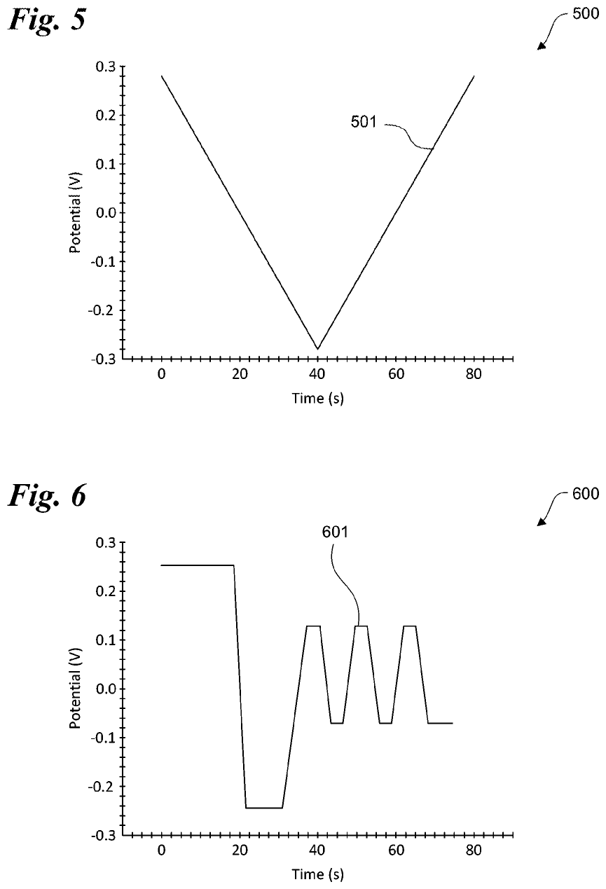

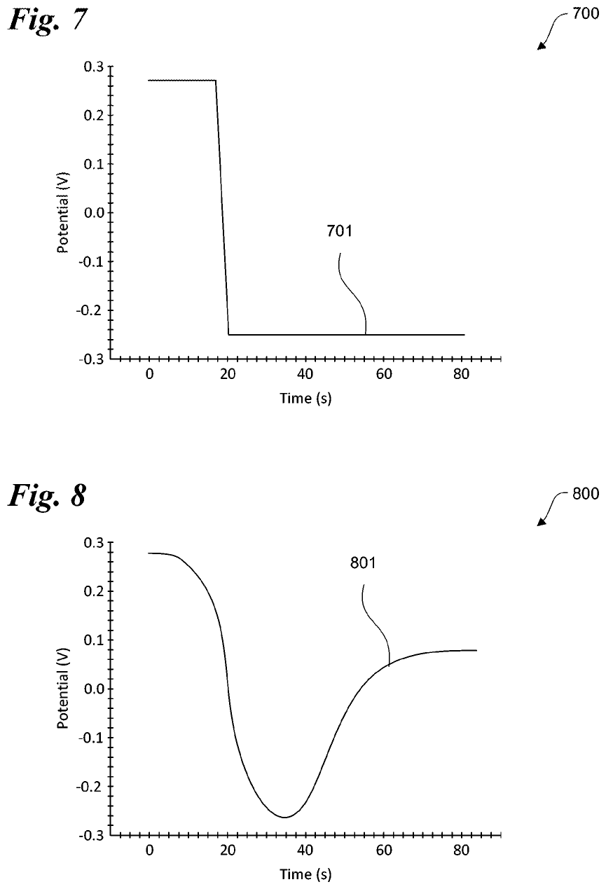

The control circuits of the present disclosure may be programmed and configured to apply different time varying voltages to the specimens in each fluid well. Any digital or analog signal may be applied to the specimens, and several examples are provided in FIGS. 5-8. The signals may be generated by reprogrammable control logic such as an FPGA, or other processor, or by electronic circuitry that is preconfigured to provide fixed predetermined wave forms. FIGS. 5, 6, and 7 illustrate digital signals 501, 601, and 701 respectively, while FIG. 8 illustrates an analog signal 801. In FIG. 5, a scan rate of signal 501 is determined by controlling the potential step size and dwell time at each step as the signal varies from a high potential, to a low potential, and back to a high potential. A more complex signal 601 is illustrated in FIG. 6 where the changes in potential involve stepping the potential to an initial value for a set time, then to a second potential, followed by a series of potential steps, the frequency of which may be adjustable according to software or hardware in the control circuits. In another example, a stepped potential signal 701 in FIG. 7 involves a simple potential step and hold which may be useful for coulometric analysis and controlled potential electrolyses.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus, a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Controller” or “control circuit” generally refers to a mechanical or electronic device configured to control the behavior of another mechanical or electronic device. A controller or “control circuit” is optionally configured to provide signals or other electrical impulses that may be received and interpreted by the controlled device to indicate how it should behave.

“Communication Link” generally refers to a connection between two or more communicating entities. The communication between the communicating entities may occur by any suitable means. For example the connection may be implemented as a physical link, an electrical link, an electromagnetic link, a logical link, or any other suitable linkage facilitating communication.

In the case of a physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass via electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Electrically connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the X8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the FX, Phenom, Athlon, Sempron, or Opteron processors manufactured by Advanced Micro Devices of Sunnyvale, California, USA; or the Snapdragon SoC processors manufactured by Qalcomm of San Diego, California, USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

1. A potentiostat comprising:
multiple separate fluid wells defined by a fluid well assembly;
multiple individual QRC electrodes positioned to extend into multiple fluid specimens in the multiple separate fluid wells;
a common working electrode;
a control circuit electrically connected to the multiple QRC electrodes and the single working electrode;
wherein the control circuit is configured to generate a time varying signal across the QRC electrodes and the working electrode, and to sense the resulting current using the QRC electrode.

2. The potentiostat of claim 1, wherein the fluid well assembly includes:
a top plate;
a gasket;
the common working electrode, wherein the common working electrode includes a working electrode plate;
a conductive plate electrically connecting the working electrode plate to the control circuit;
a bottom plate, wherein the top plate, bottom plate, and gasket are electrically insulative.

3. The potentiostat of claim 2, wherein the multiple separate fluid wells are defined by the top plate and the gasket.

4. The potentiostat of claim 1, wherein the QRC electrodes extend into the multiple separate fluid wells from the top, and wherein the common working electrode extends into the fluid wells from the bottom.

5. The potentiostat of claim 1, wherein the multiple separate fluid wells are arranged in a grid of rows and columns.

6. The potentiostat of claim 1, wherein each of the multiple individual QRC electrodes extends into each of the multiple separate fluid wells.

7. The potentiostat of claim 1, wherein the control circuit is configured to generate the same time varying signal to two or more of the multiple QRC electrodes.

8. The potentiostat of claim 1, wherein the control circuit is configured to generate a different varying signal to at least two separate electrodes of the multiple QRC electrodes.

9. The potentiostat of claim 1, wherein the control circuit is configured to generate a first time varying signal to a first portion of the multiple QRC electrodes, and a second different time varying signal to a second different portion of the multiple QRC electrodes.

10. The potentiostat of claim 1, wherein the control circuit is configured to generate a different varying signal to two or more of the multiple QRC electrodes at about the same time.

11. The potentiostat of claim 1, wherein the control circuit includes an FPGA that is programmed to generate the time varying signals.

12. The potentiostat of claim 1, wherein the control circuit includes an operational amplifier configured to detect the resulting current.

13. The potentiostat of claim 1, wherein the multiple separate fluid wells include 4 fluid wells, or more.

14. The potentiostat of claim 1, wherein the multiple individual QRC electrode includes 4 separate electrodes, or more.

15. The potentiostat of claim 1, wherein the multiple separate fluid wells include 96 fluid wells, or more.

16. The potentiostat of claim 1, wherein the multiple individual QRC electrode includes 96 separate electrodes, or more.
